(19) United States
(12) Patent Application Publication
(10) Pub. No.: US 2025/0246374 A1
(43) Pub. Date: Jul. 31, 2025

(54) WOUND CAPACITOR PACKAGE STRUCTURE AND METHOD FOR MANUFACTURING THE SAME, AND MOVABLE DEVICE

(71) Applicant: APAQ TECHNOLOGY CO., LTD., Miaoli County (TW)

(72) Inventors: CHUNG-JUI SU, KAOHSIUNG CITY (TW); MING-TSUNG LIANG, NEW TAIPEI CITY (TW)

(21) Appl. No.: 18/653,367

(22) Filed: May 2, 2024

(30) Foreign Application Priority Data
Jan. 26, 2024 (TW) 113103066

(51) Int. Cl. H01G 9/10; H01G 9/008; H01G 9/15; H01G 13/00

(52) U.S. Cl. CPC H01G 9/10; H01G 9/151; H01G 13/003; H01G 9/008

(57) ABSTRACT

A wound capacitor package structure and a method for manufacturing the same, and a movable device are provided. The wound capacitor package structure includes a wound assembly, a conductive assembly, a packaging casing, an elastic sealing component and an elastic buffer body. The conductive assembly includes a first conductive pin and a second conductive pin. The packaging casing is configured to accommodate the wound assembly. The elastic sealing component is disposed inside the packaging casing. The elastic sealing component is configured to isolate the wound assembly from an external environment. The elastic buffer body is disposed on a first surface of the elastic sealing component and surrounded by the packaging casing. The elastic buffer body is configured to slow down an impact force caused by an external force on the wound assembly and reduce a thermal shock caused by an external temperature on the wound assembly.

### CROSS-REFERENCE TO RELATED PATENT APPLICATION

This application claims the benefit of priority to Taiwan Patent Application No. 113103066, filed on Jan. 26, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a capacitor package structure, and more particularly to a wound capacitor package structure and a method for manufacturing the same, and a movable device configured to use the wound capacitor package structure.

### BACKGROUND OF THE DISCLOSURE

In the related art, various applications of capacitors include being used in home appliances, computer motherboards and peripherals, power supplies, communication products and automobiles. Capacitors such as solid electrolytic capacitors are mainly used to provide functions such as filtering, bypassing, rectifying, coupling, blocking and transforming. However, there is still room for improvement in the related art of the wound capacitor.

### SUMMARY OF THE DISCLOSURE

In response to the above-referenced technical inadequacy, the present disclosure provides a wound capacitor package structure and a method for manufacturing the same, and a movable device configured to use the wound capacitor package structure, which utilizes an elastic buffer body to slow down an impact force caused by an external force on the wound assembly and reduce a thermal shock caused by an external temperature on the wound assembly.

In order to solve the above-mentioned problems, one of the technical aspects adopted by the present disclosure is to provide a wound capacitor package structure, which includes a wound assembly, a conductive assembly, a packaging casing, an elastic sealing component and an elastic buffer body. The conductive assembly includes a first conductive pin and a second conductive pin. The packaging casing is configured to accommodate the wound assembly. The elastic sealing component is disposed inside the packaging casing and cooperates with the packaging casing, and the elastic sealing component is configured to isolate the wound assembly from an external environment. The elastic buffer body is disposed on a first surface of the elastic sealing component and surrounded by the packaging casing, and the elastic buffer body is configured to slow down an impact force caused by an external force on the wound assembly and reduce a thermal shock caused by an external temperature on the wound assembly. The first conductive pin includes a first embedded portion accommodated inside the packaging casing and a first exposed portion exposed outside the packaging casing, and the second conductive pin includes a second embedded portion accommodated inside the packaging casing and a second exposed portion exposed outside the packaging casing. The packaging casing has a surrounding concave position-limiting portion recessed inward to press the elastic sealing component, and a surrounding convex end portion protruding from the surrounding concave position-limiting portion to abut against the elastic sealing component.

In order to solve the above-mentioned problems, another one of the technical aspects adopted by the present disclosure is to provide a movable device configured to use a wound capacitor package structure. The wound capacitor package structure includes a wound assembly, a conductive assembly, a packaging casing, an elastic sealing component and an elastic buffer body. The conductive assembly includes a first conductive pin and a second conductive pin. The packaging casing is configured to accommodate the wound assembly. The elastic sealing component is disposed inside the packaging casing and cooperates with the packaging casing, and the elastic sealing component is configured to isolate the wound assembly from an external environment. The elastic buffer body is disposed on a first surface of the elastic sealing component and surrounded by the packaging casing, and the elastic buffer body is configured to slow down an impact force caused by an external force on the wound assembly and reduce a thermal shock caused by an external temperature on the wound assembly. The first conductive pin includes a first embedded portion accommodated inside the packaging casing and a first exposed portion exposed outside the packaging casing, and the second conductive pin includes a second embedded portion accommodated inside the packaging casing and a second exposed portion exposed outside the packaging casing. The packaging casing has a surrounding concave position-limiting portion recessed inward to press the elastic sealing component, and a surrounding convex end portion protruding from the surrounding concave position-limiting portion to abut against the elastic sealing component.

In order to solve the above-mentioned problems, yet another one of the technical aspects adopted by the present disclosure is to provide a method for manufacturing a wound capacitor package structure, which includes: providing a semi-finished wound capacitor, in which the semi-finished wound capacitor includes a wound assembly, a conductive assembly, a packaging casing and an elastic sealing component that cooperate with each other; forming an elastic buffer material on a first surface of the elastic sealing component; and curing the elastic buffer material to form an elastic buffer body. The elastic buffer body is configured to slow down an impact force caused by an external force on the wound assembly and reduce a thermal shock caused by an external temperature on the wound assembly.

Therefore, in the wound capacitor package structure and the movable device using the wound capacitor package structure provided by the present disclosure, by virtue of “the elastic buffer body being disposed on a first surface of the elastic sealing component and surrounded by the packaging casing,” the elastic buffer body can be configured to slow down an impact force caused by an external force on the wound assembly and reduce a thermal shock caused by an external temperature on the wound assembly.

Furthermore, in the method for manufacturing the wound capacitor package structure provided by the present disclosure, by virtue of “providing a semi-finished wound capacitor, in which the semi-finished wound capacitor includes a wound assembly, a conductive assembly, a packaging casing and an elastic sealing component that cooperate with each other,” “forming an elastic buffer material on a first surface of the elastic sealing component” and “curing the elastic buffer material to form an elastic buffer body,” the elastic buffer body can be configured to slow down an impact force caused by an external force on the wound assembly and reduce a thermal shock caused by an external temperature on the wound assembly.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a manufacturing method of a wound capacitor package structure provided by the present disclosure;

FIG. 2 is a schematic perspective view of a wound assembly and a conductive assembly cooperating with each other according to the present disclosure;

FIG. 3 is a schematic view of the wound assembly being positioned inside the packaging casing through a bottom positioning glue material according to a first embodiment of the present disclosure;

FIG. 4 is a schematic view of a semi-finished wound capacitor provided by the first embodiment of the present disclosure;

FIG. 5 is a schematic view of a first type of the wound capacitor package structure provided by the first embodiment of the present disclosure;

FIG. 6 is a schematic view of a second type of the wound capacitor package structure provided by the first embodiment of the present disclosure;

FIG. 7 is a schematic view of the wound assembly being positioned inside the packaging casing through a bottom positioning glue material according to a second embodiment of the present disclosure;

FIG. 8 is a schematic view of the wound assembly being surrounded and covered by a surrounding connecting glue material according to the second embodiment of the present disclosure;

FIG. 9 is a schematic view of the semi-finished wound capacitor according to the second embodiment of the present disclosure;

FIG. 10 is a schematic view of a first type of the wound capacitor package structure provided by the second embodiment of the present disclosure;

FIG. 11 is a schematic view of a second type of the wound capacitor package structure provided by the second embodiment of the present disclosure; and

FIG. 12 is a functional block diagram of a movable device using the wound capacitor package structure according to a third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

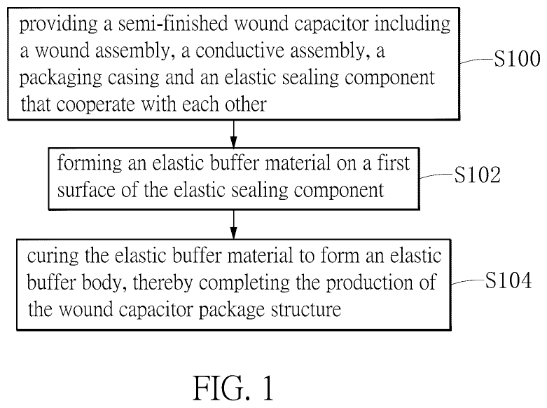

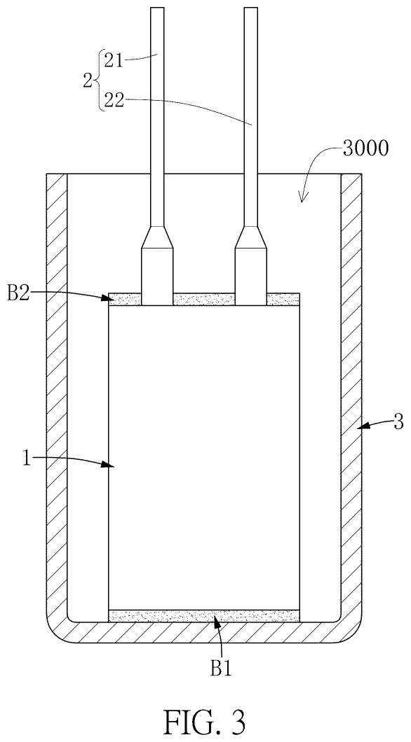

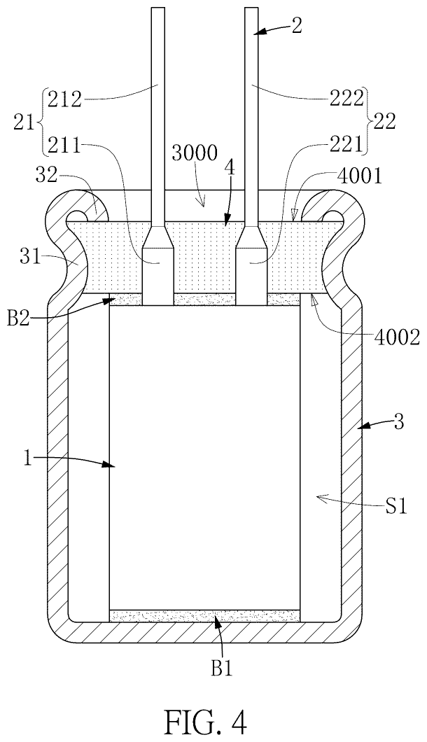

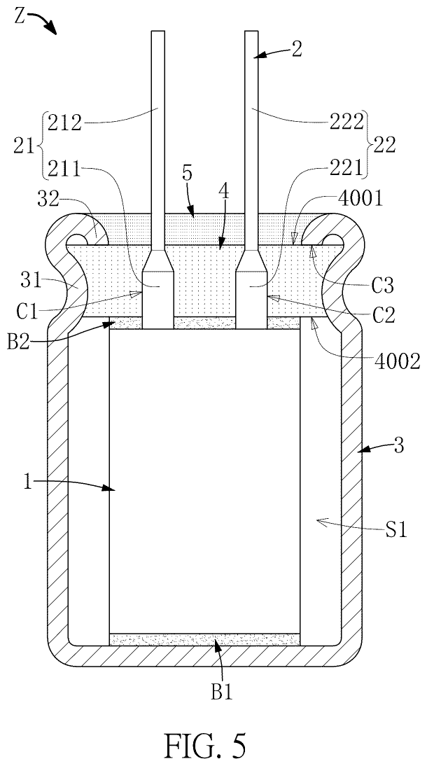

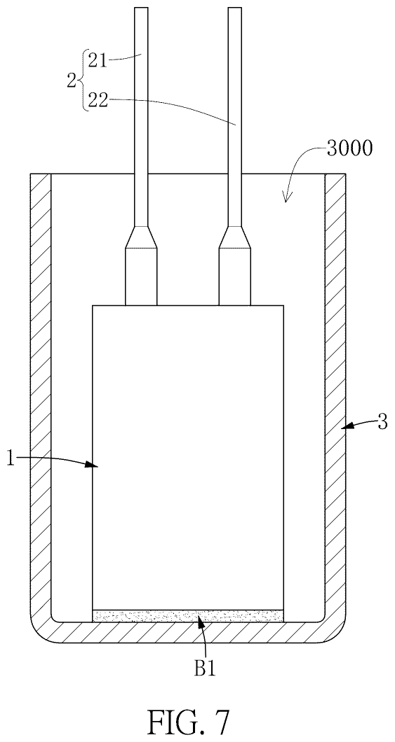

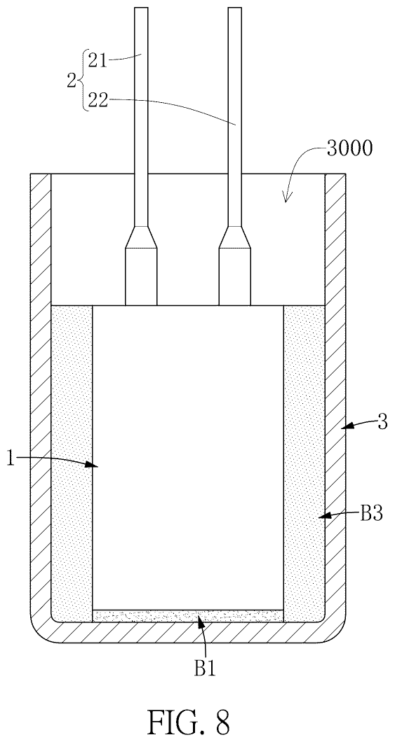

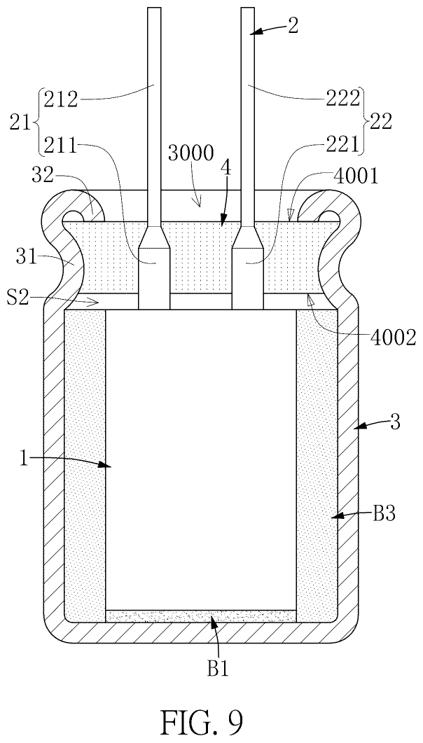

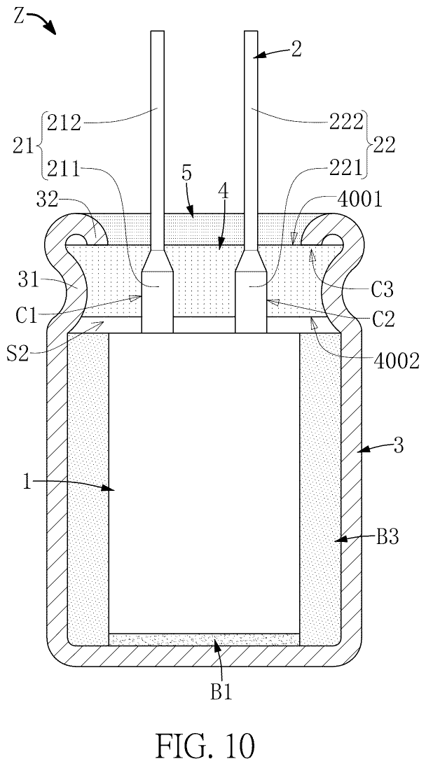

Referring to FIG. 1 to FIG. 11, the present disclosure provides a method for manufacturing a wound capacitor package structure Z, which includes: firstly, referring to FIG. 1, FIG. 3 and FIG. 4 (or FIG. 1, FIG. 7, FIG. 8 and FIG. 9), providing a semi-finished wound capacitor (i.e., a semi-finished product), in which the semi-finished wound capacitor includes a wound assembly 1, a conductive assembly 2, a packaging casing 3 and an elastic sealing component 4 that cooperate with each other (step S100); next, referring to FIG. 1 and FIG. 5 (or FIG. 1 and FIG. 10), forming an elastic buffer material (such as any uncured elastic material of an elastic buffer body 5 before curing) on a first surface 4001 of the elastic sealing component 4 (step S102); and then curing the elastic buffer material to form an elastic buffer body 5, thereby completing the production of the wound capacitor package structure Z (step S104). It should be noted that, as shown in FIG. 5 and FIG. 10, the elastic buffer body 5 can be configured to slow down (or retard or reduce) an impact force caused by an external force (such as an impact force exerted or acting on the elastic buffer body 5) on the wound assembly 1, to reduce a thermal shock (such as an external high temperature or an ambient high temperature adjacent to the elastic buffer body 5) caused by an external temperature on the wound assembly 1, and to reduce the possibility that external moisture enters the inside of the wound capacitor package structure Z and causes oxidation of the wound assembly 1.

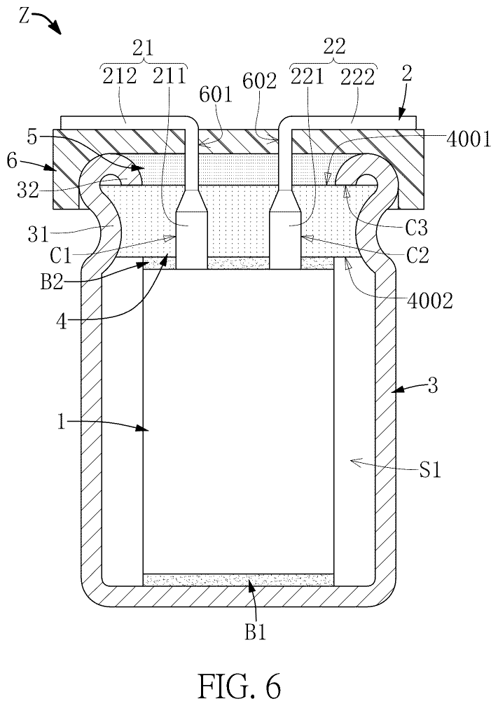

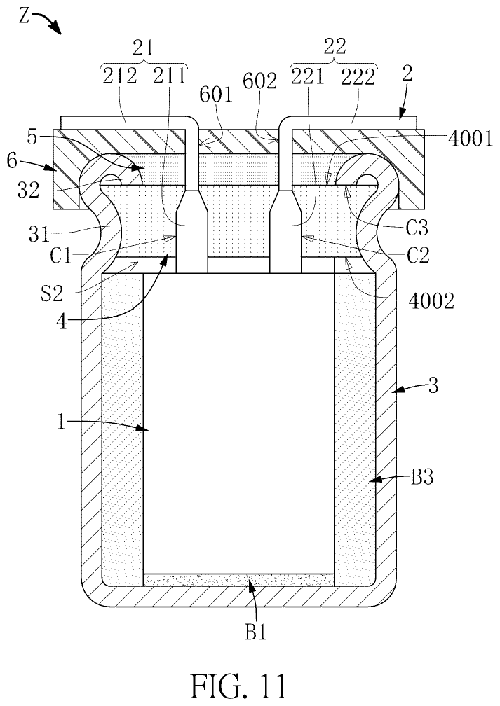

For example, as shown in FIG. 6 or FIG. 11, the wound capacitor package structure Z further includes a bottom seat plate 6 (or a bottom carry plate or a bottom holder), and the bottom seat plate 6 can be configured to be disposed at a bottom side of the packaging casing 3 for cooperating with the packaging casing 3. More particularly, bottom seat plate 6 has a first through hole 601 and a second through hole 602, and a first exposed portion 212 of a first conductive pin 21 and a second exposed portion 222 of a second conductive pin 22 provided by conductive assembly 2 can respectively pass through the first through hole 601 and the second through hole 602 of the bottom seat plate 6, and the first exposed portion 212 of the first conductive pin 21 and the second exposed portion 222 of the second conductive pin 22 can extend in different directions by bending. However, the aforementioned details are disclosed for exemplary purposes only, and are not meant to limit the scope of the present disclosure.

### First Embodiment

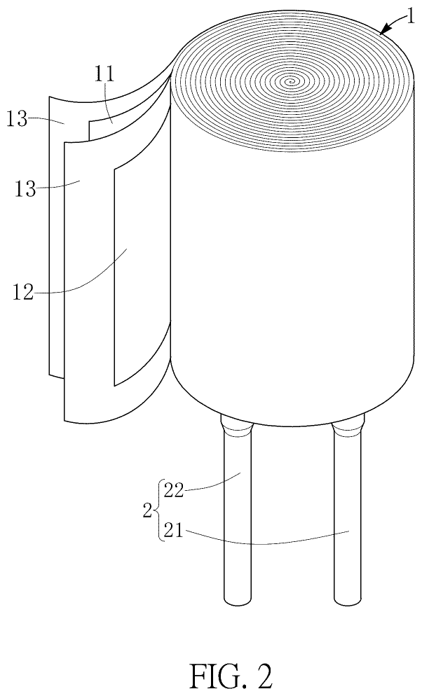

Referring to FIG. 2 and FIG. 3 to FIG. 3, a first embodiment of the present disclosure provides a wound capacitor package structure Z, which includes a wound assembly 1, a conductive assembly 2, a packaging casing 3 (or a package shell), an elastic sealing component 4 and an elastic buffer body 5 (or an elastic cushioning body).

Firstly, as shown in FIG. 2, the wound assembly 1 can be positioned inside the packaging casing 3 through a bottom positioning glue material B1 (such as silicone or epoxy resin). For example, the wound assembly 1 includes a wound positive conductive foil 11, a wound negative conductive foil 12 and two wound insulating separators 13. More particularly, one of the two wound insulating separators 13 can be disposed between the wound positive conductive foil 11 and the wound negative conductive foil 12, and one of the wound positive conductive foil 11 and the wound negative conductive foil 12 can be disposed between the two wound insulating separators 13. In addition, the wound insulating separator 13 can be an insulating paper or insulating foil containing a dipping material such as a conductive polymer. However, the aforementioned details are disclosed for exemplary purposes only, and are not meant to limit the scope of the present disclosure.

Furthermore, referring to FIG. 2 and FIG. 4, the conductive assembly 2 includes a first conductive pin 21 and a second conductive pin 22. More particularly, the first conductive pin 21 includes a first embedded portion 211 accommodated inside the packaging casing 3 and a first exposed portion 212 exposed outside the packaging casing 3, and the second conductive pin 22 includes a second embedded portion 221 accommodated inside the packaging casing 3 and a second exposed portion 222 exposed outside the packaging casing 3. In addition, the first conductive pin 21 and the second conductive pin 22 of the conductive assembly 2 electrically contact the wound positive conductive foil 11 and the wound negative conductive foil 12, respectively. For example, the first conductive pin 21 and the second conductive pin 22 of the conductive assembly 2 may be made of copper material, aluminum material or any other conductive material. However, the aforementioned details are disclosed for exemplary purposes only, and are not meant to limit the scope of the present disclosure.

Moreover, referring to FIG. 3 and FIG. 4, the packaging casing 3 can be configured to accommodate the wound assembly 1. More particularly, the packaging casing 3 has a surrounding concave position-limiting portion 31 (or a surrounding inward recessed structure) recessed inward to press the elastic sealing component 4, and a surrounding convex end portion 32 (or a surrounding inward curved structure) protruding from the surrounding concave position-limiting portion 31 to abut against the elastic sealing component 4. In addition, the packaging casing 3 has an accommodating opening 3000, and the elastic sealing component 4 can be disposed at the accommodating opening 3000 of the packaging casing 3 for closing and sealing the accommodating opening 3000 of the packaging casing 3. For example, the packaging casing 3 can be an aluminum shell or any kind of metal shell. However, the aforementioned details are disclosed for exemplary purposes only, and are not meant to limit the scope of the present disclosure.

In addition, referring to FIG. 3 and FIG. 4, the elastic sealing component 4 is disposed inside the packaging casing 3 and cooperates with the packaging casing 3, and the elastic sealing component 4 can be configured to isolate the wound assembly 1 from an external environment. Moreover, the wound assembly 1 can be connected to a second surface 4002 of the elastic sealing component 4 through a top connecting glue material B2 (such as silicone or epoxy resin), and an unoccupied surrounding space S1 is formed between the wound assembly 1 and the packaging casing 3. For example, the elastic sealing element 4 may be made of polyurethane rubber, acrylate rubber, fluoro rubber, nitrile butadiene rubber or any elastic material. In addition, the fluorine rubber may be chlorohydrin rubber, fluorosilicone rubber, or fluoro-phosphazene rubber, and the nitrile rubber may be hydrogenated nitrile rubber. In addition, in other possible embodiments, the top connecting glue material B2 can also be omitted and not used, so that an unoccupied spacing space can be formed between the wound assembly 1 and the elastic sealing component 4. However, the aforementioned details are disclosed for exemplary purposes only, and are not meant to limit the scope of the present disclosure.

Furthermore, referring to FIG. 4 and FIG. 5, the elastic buffer body 5 is disposed on a first surface 4001 of the elastic sealing component 4 and surrounded by the packaging casing 3 (for example, the packaging casing 3 may be configured to completely or partially surround the elastic buffer body 5), and the elastic buffer body 5 can be configured to slow down an impact force caused by an external force (such as an impact force exerted or acting on the elastic buffer body 5) on the wound assembly 1 and reduce a thermal shock (such as an external high temperature or an ambient high temperature adjacent to the elastic buffer body 5) caused by an external temperature on the wound assembly 1. In addition, the first surface 4001 of the elastic sealing component 4 can be completely covered by the elastic buffer body 5, so that the elastic buffer body 5 can be configured to protect the elastic sealing component 4. For example, the elastic buffer body 5 can be made of silicone, epoxy resin or any kind of elastic buffer material. In addition, the elastic sealing component 4 and the elastic buffer body 5 have the same or different thermal insulation coefficients, the elastic sealing component 4 and the elastic buffer body 5 have the same or different elastic coefficients, and the elastic sealing component 4 and the elastic buffer body 5 have the same or different heat resistances. However, the aforementioned details are disclosed for exemplary purposes only, and are not meant to limit the scope of the present disclosure.

For example, as shown in FIG. 5, the wound capacitor package structure Z further includes a bottom seat plate 6, and the bottom seat plate 6 can be configured at a bottom side of the packaging casing 3 for cooperating with the packaging casing 3. More particularly, the bottom seat plate 6 has a first through hole 601 and a second through hole 602, and the first exposed portion 212 of the first conductive pin 21 and the second exposed portion 222 of the second conductive pin 22 can respectively pass through the first through hole 601 and the second through hole 602 of the bottom seat plate 6, and the first exposed portion 212 of the first conductive pin 21 and the second exposed portion 222 of the second conductive pin 22 can extend in different directions by bending. However, the aforementioned details are disclosed for exemplary purposes only, and are not meant to limit the scope of the present disclosure.

It should be noted that, as shown in FIG. 5 or FIG. 6, a part of the first embedded portion 211 of the first conductive pin 21 is surrounded and covered (or surroundingly covered) by the elastic buffer body 5, so that the elastic buffer body 5 can be configured to block or prevent external moisture from contacting the wound assembly 1 through a first contact interface C1 between the first conductive pin 21 (or the first embedded portion 211) and the elastic sealing component 4, thereby avoiding generating (or forming) a first moisture path between the first conductive pin 21 and the elastic sealing component 4. Moreover, a part of the second embedded portion 221 of the second conductive pin 22 is surrounded and covered (or surroundingly covered) by the elastic buffer body 5, so that the elastic buffer body 5 can be configured to block or prevent external moisture from contacting the wound assembly 1 through a second contact interface C2 between the second conductive pin 22 (or the second embedded portion 221) and the elastic sealing component 4, thereby avoiding generating (or forming) a second moisture path between the second conductive pin 22 and the elastic sealing component 4. In addition, an inner surrounding surface of the surrounding convex end portion 32 of the packaging casing 3 is covered by the elastic buffer body 5, so that the elastic buffer body 5 can be configured to block or prevent external moisture from contacting the wound assembly 1 through a third contact interface C3 between the surrounding convex end portion 32 and the elastic sealing component 4, thereby avoiding generating (or forming) a third moisture path between the surrounding convex end portion 32 and the elastic sealing component 4. Therefore, the elastic buffer body 5 can be configured to reduce the possibility that external moisture enters the inside of the wound capacitor package structure Z and causes oxidation of the wound assembly 1 (or reduce the possibility of external moisture entering the inside of the wound capacitor package structure Z and causing oxidation of the wound assembly 1).

### Second Embodiment

Referring to FIG. 2 and FIG. 7 to FIG. 11, a second embodiment of the present disclosure provides a wound capacitor package structure Z, which includes a wound assembly 1, a conductive assembly 2, a packaging casing 3, an elastic sealing component 4 and an elastic buffer body 5. Comparing FIG. 3 with FIG. 7 and FIG. 8, comparing FIG. 4 with FIG. 9, comparing FIG. 5 with FIG. 10, and comparing FIG. 6 with FIG. 11, the main difference between the second embodiment and the first embodiment is as follows: in the second embodiment, the wound assembly 1 is surrounded and covered (or surroundingly covered) by a surrounding connecting glue material B3 that is connected between the wound assembly 1 and the packaging casing 3 (that is to say, there is no unoccupied surrounding space formed between the wound assembly 1 and the packaging casing 3), and an unoccupied spacing space S2 is formed between the wound assembly 1 and the elastic sealing component 4.

### Third Embodiment

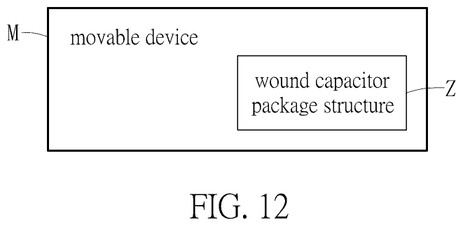

Referring to FIG. 12, a third embodiment of the present disclosure provides a movable device M (for example, any means of transportation such as cars, boats, airplanes, etc., or it can also be a portable electronic device, such as a laptop computer), and the movable device M can be configured to use the wound capacitor package structure Z as provided in the first and second embodiments. For example, the wound capacitor package structure Z can be installed inside the movable device M through the support of the circuit substrate.

### [Beneficial Effects of the Embodiments]

In conclusion, in the wound capacitor package structure Z and the movable device using the wound capacitor package structure Z provided by the present disclosure, by virtue of “the elastic buffer body 5 being disposed on a first surface 4001 of the elastic sealing component 4 and surrounded by the packaging casing 3,” the elastic buffer body 5 can be configured to slow down an impact force caused by an external force on the wound assembly 1 and reduce a thermal shock caused by an external temperature on the wound assembly 1.

Furthermore, in the method for manufacturing the wound capacitor package structure Z provided by the present disclosure, by virtue of “providing a semi-finished wound capacitor, in which the semi-finished wound capacitor includes a wound assembly 1, a conductive assembly 2, a packaging casing 3 and an elastic sealing component 4 that cooperate with each other,” “forming an elastic buffer material on a first surface 4001 of the elastic sealing component 4” and “curing the elastic buffer material to form an elastic buffer body 5,” the elastic buffer body 5 can be configured to slow down an impact force caused by an external force on the wound assembly 1 and reduce a thermal shock caused by an external temperature on the wound assembly 1.

Moreover, the elastic buffer body 5 can be configured to block or prevent external moisture from contacting the wound assembly 1 through a first contact interface C1 between the first conductive pin 21 and the elastic sealing component 4, thereby avoiding generating a first moisture path between the first conductive pin 21 and the elastic sealing component 4. Moreover, the elastic buffer body 5 can be configured to block or prevent external moisture from contacting the wound assembly 1 through a second contact interface C2 between the second conductive pin 22 and the elastic sealing component 4, thereby avoiding generating a second moisture path between the second conductive pin 22 and the elastic sealing component 4. In addition, the elastic buffer body 5 can be configured to block or prevent external moisture from contacting the wound assembly 1 through a third contact interface C3 between the surrounding convex end portion 32 and the elastic sealing component 4, thereby avoiding generating a third moisture path between the surrounding convex end portion 32 and the elastic sealing component 4. Therefore, the elastic buffer body 5 can be configured to reduce the possibility that external moisture enters the inside of the wound capacitor package structure Z and causes oxidation of the wound assembly 1.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A wound capacitor package structure, comprising:
a wound assembly;
a conductive assembly including a first conductive pin and a second conductive pin;
a packaging casing configured to accommodate the wound assembly;
an elastic sealing component disposed inside the packaging casing and cooperating with the packaging casing, wherein the elastic sealing component is configured to isolate the wound assembly from an external environment; and
an elastic buffer body disposed on a first surface of the elastic sealing component and surrounded by the packaging casing, wherein the elastic buffer body is configured to slow down an impact force caused by an external force on the wound assembly and reduce a thermal shock caused by an external temperature on the wound assembly;
wherein the first conductive pin includes a first embedded portion accommodated inside the packaging casing and a first exposed portion exposed outside the packaging casing, and the second conductive pin includes a second embedded portion accommodated inside the packaging casing and a second exposed portion exposed outside the packaging casing;
wherein the packaging casing has a surrounding concave position-limiting portion recessed inward to press the elastic sealing component, and a surrounding convex end portion protruding from the surrounding concave position-limiting portion to abut against the elastic sealing component.

2. The wound capacitor package structure according to claim 1,
wherein the wound assembly is positioned inside the packaging causing through a bottom positioning glue material, the wound assembly is connected to a second surface of the elastic sealing component through a top connecting glue material, and an unoccupied surrounding space is formed between the wound assembly and the packaging casing;
wherein the packaging casing has an accommodating opening, and the elastic sealing component is disposed at the accommodating opening of the packaging casing for closing and sealing the accommodating opening of the packaging casing;
wherein the first surface of the elastic sealing component is completely covered by the elastic buffer body, and the elastic buffer body is configured to protect the elastic sealing component;
wherein a part of the first embedded portion of the first conductive pin is surrounded and covered by the elastic buffer body, so that the elastic buffer body is configured to block external moisture from contacting the wound assembly through a first contact interface between the first conductive pin and the elastic sealing component, thereby avoiding generating a first moisture path between the first conductive pin and the elastic sealing component;
wherein a part of the second embedded portion of the second conductive pin is surrounded and covered by the elastic buffer body, so that the elastic buffer body is configured to block external moisture from contacting the wound assembly through a second contact interface between the second conductive pin and the elastic sealing component, thereby avoiding generating a second moisture path between the second conductive pin and the elastic sealing component;
wherein an inner surrounding surface of the surrounding convex end portion of the packaging casing is covered by the elastic buffer body, so that the elastic buffer body is configured to block external moisture from contacting the wound assembly through a third contact interface between the surrounding convex end portion and the elastic sealing component, thereby avoiding generating a third moisture path between the surrounding convex end portion and the elastic sealing component;
wherein the elastic sealing component and the elastic buffer body have the same or different thermal insulation coefficients, the elastic sealing component and the elastic buffer body have the same or different elastic coefficients, and the elastic sealing component and the elastic buffer body have the same or different heat resistances;
wherein the wound capacitor package structure further includes a bottom seat plate, and the bottom seat plate is configured at a bottom side of the packaging casing for cooperating with the packaging casing;
wherein the bottom seat plate has a first through hole and a second through hole, and the first exposed portion of the first conductive pin and the second exposed portion of the second conductive pin respectively pass through the first through hole and the second through hole of the bottom seat plate, and the first exposed portion of the first conductive pin and the second exposed portion of the second conductive pin extend in different directions by bending.

3. The wound capacitor package structure according to claim 1,
wherein the wound assembly is positioned inside the packaging causing through a bottom positioning glue material, an unoccupied spacing space is formed between the wound assembly and the elastic sealing component, and an unoccupied surrounding space is formed between the wound assembly and the packaging casing;
wherein the packaging casing has an accommodating opening, and the elastic sealing component is disposed at the accommodating opening of the packaging casing for closing and sealing the accommodating opening of the packaging casing;
wherein the first surface of the elastic sealing component is completely covered by the elastic buffer body, and the elastic buffer body is configured to protect the elastic sealing component;
wherein a part of the first embedded portion of the first conductive pin is surrounded and covered by the elastic buffer body, so that the elastic buffer body is configured to block external moisture from contacting the wound assembly through a first contact interface between the first conductive pin and the elastic sealing component, thereby avoiding generating a first moisture path between the first conductive pin and the elastic sealing component;
wherein a part of the second embedded portion of the second conductive pin is surrounded and covered by the elastic buffer body, so that the elastic buffer body is configured to block external moisture from contacting the wound assembly through a second contact interface between the second conductive pin and the elastic sealing component, thereby avoiding generating a second moisture path between the second conductive pin and the elastic sealing component;
wherein an inner surrounding surface of the surrounding convex end portion of the packaging casing is covered by the elastic buffer body, so that the elastic buffer body is configured to block external moisture from contacting the wound assembly through a third contact interface between the surrounding convex end portion and the elastic sealing component, thereby avoiding generating a third moisture path between the surrounding convex end portion and the elastic sealing component;
wherein the elastic sealing component and the elastic buffer body have the same or different thermal insulation coefficients, the elastic sealing component and the elastic buffer body have the same or different elastic coefficients, and the elastic sealing component and the elastic buffer body have the same or different heat resistances;
wherein the wound capacitor package structure further includes a bottom seat plate, and the bottom seat plate is configured at a bottom side of the packaging casing for cooperating with the packaging casing;
wherein the bottom seat plate has a first through hole and a second through hole, and the first exposed portion of the first conductive pin and the second exposed portion of the second conductive pin respectively pass through the first through hole and the second through hole of the bottom seat plate, and the first exposed portion of the first conductive pin and the second exposed portion of the second conductive pin extend in different directions by bending.

4. The wound capacitor package structure according to claim 1,
wherein the wound assembly is positioned inside the packaging causing through a bottom positioning glue material, the wound assembly is surrounded and covered by a surrounding connecting glue material that is connected between the wound assembly and the packaging casing, and an unoccupied spacing space is formed between the wound assembly and the elastic sealing component;
wherein the packaging casing has an accommodating opening, and the elastic sealing component is disposed at the accommodating opening of the packaging casing for closing and sealing the accommodating opening of the packaging casing;
wherein the first surface of the elastic sealing component is completely covered by the elastic buffer body, and the elastic buffer body is configured to protect the elastic sealing component;
wherein a part of the first embedded portion of the first conductive pin is surrounded and covered by the elastic buffer body, so that the elastic buffer body is configured to block external moisture from contacting the wound assembly through a first contact interface between the first conductive pin and the elastic sealing component, thereby avoiding generating a first moisture path between the first conductive pin and the elastic sealing component;
wherein a part of the second embedded portion of the second conductive pin is surrounded and covered by the elastic buffer body, so that the elastic buffer body is configured to block external moisture from contacting the wound assembly through a second contact interface between the second conductive pin and the elastic sealing component, thereby avoiding generating a second moisture path between the second conductive pin and the elastic sealing component;
wherein an inner surrounding surface of the surrounding convex end portion of the packaging casing is covered by the elastic buffer body, so that the elastic buffer body is configured to block external moisture from contacting the wound assembly through a third contact interface between the surrounding convex end portion and the elastic sealing component, thereby avoiding generating a third moisture path between the surrounding convex end portion and the elastic sealing component;
wherein the elastic sealing component and the elastic buffer body have the same or different thermal insulation coefficients, the elastic sealing component and the elastic buffer body have the same or different elastic coefficients, and the elastic sealing component and the elastic buffer body have the same or different heat resistances;
wherein the wound capacitor package structure further includes a bottom seat plate, and the bottom seat plate is configured at a bottom side of the packaging casing for cooperating with the packaging casing;
wherein the bottom seat plate has a first through hole and a second through hole, and the first exposed portion of the first conductive pin and the second exposed portion of the second conductive pin respectively pass through the first through hole and the second through hole of the bottom seat plate, and the first exposed portion of the first conductive pin and the second exposed portion of the second conductive pin extend in different directions by bending.

5. A movable device configured to use a wound capacitor package structure, characterized in that the wound capacitor package structure comprises:
a wound assembly;
a conductive assembly including a first conductive pin and a second conductive pin;
a packaging casing configured to accommodate the wound assembly;
an elastic sealing component disposed inside the packaging casing and cooperating with the packaging casing, wherein the elastic sealing component is configured to isolate the wound assembly from an external environment; and
an elastic buffer body disposed on a first surface of the elastic sealing component and surrounded by the packaging casing, wherein the elastic buffer body is configured to slow down an impact force caused by an external force on the wound assembly and reduce a thermal shock caused by an external temperature on the wound assembly;
wherein the first conductive pin includes a first embedded portion accommodated inside the packaging casing and a first exposed portion exposed outside the packaging casing, and the second conductive pin includes a second embedded portion accommodated inside the packaging casing and a second exposed portion exposed outside the packaging casing;
wherein the packaging casing has a surrounding concave position-limiting portion recessed inward to press the elastic sealing component, and a surrounding convex end portion protruding from the surrounding concave position-limiting portion to abut against the elastic sealing component.

6. The movable device according to claim 5,
wherein the wound assembly is positioned inside the packaging casing through a bottom positioning glue material, the wound assembly is connected to a second surface of the elastic sealing component through a top connecting glue material, and an unoccupied surrounding space is formed between the wound assembly and the packaging casing;
wherein the packaging casing has an accommodating opening, and the elastic sealing component is disposed at the accommodating opening of the packaging casing for closing and sealing the accommodating opening of the packaging casing;
wherein the first surface of the elastic sealing component is completely covered by the elastic buffer body, and the elastic buffer body is configured to protect the elastic sealing component;
wherein a part of the first embedded portion of the first conductive pin is surrounded and covered by the elastic buffer body, so that the elastic buffer body is configured to block external moisture from contacting the wound assembly through a first contact interface between the first conductive pin and the elastic sealing component, thereby avoiding generating a first moisture path between the first conductive pin and the elastic sealing component;
wherein a part of the second embedded portion of the second conductive pin is surrounded and covered by the elastic buffer body, so that the elastic buffer body is configured to block external moisture from contacting the wound assembly through a second contact interface between the second conductive pin and the elastic sealing component, thereby avoiding generating a second moisture path between the second conductive pin and the elastic sealing component;
wherein an inner surrounding surface of the surrounding convex end portion of the packaging casing is covered by the elastic buffer body, so that the elastic buffer body is configured to block external moisture from contacting the wound assembly through a third contact interface between the surrounding convex end portion and the elastic sealing component, thereby avoiding generating a third moisture path between the surrounding convex end portion and the elastic sealing component;
wherein the elastic sealing component and the elastic buffer body have the same or different thermal insulation coefficients, the elastic sealing component and the elastic buffer body have the same or different elastic coefficients, and the elastic sealing component and the elastic buffer body have the same or different heat resistances;
wherein the wound capacitor package structure further includes a bottom seat plate, and the bottom seat plate is configured at a bottom side of the packaging casing for cooperating with the packaging casing;
wherein the bottom seat plate has a first through hole and a second through hole, and the first exposed portion of the first conductive pin and the second exposed portion of the second conductive pin respectively pass through the first through hole and the second through hole of the bottom seat plate, and the first exposed portion of the first conductive pin and the second exposed portion of the second conductive pin extend in different directions by bending.

7. The movable device according to claim 5,
wherein the wound assembly is positioned inside the packaging casing through a bottom positioning glue material, an unoccupied spacing space is formed between the wound assembly and the elastic sealing component, and an unoccupied surrounding space is formed between the wound assembly and the packaging casing;
wherein the packaging casing has an accommodating opening, and the elastic sealing component is disposed at the accommodating opening of the packaging casing for closing and sealing the accommodating opening of the packaging casing;
wherein the first surface of the elastic sealing component is completely covered by the elastic buffer body, and the elastic buffer body is configured to protect the elastic sealing component;
wherein a part of the first embedded portion of the first conductive pin is surrounded and covered by the elastic buffer body, so that the elastic buffer body is configured to block external moisture from contacting the wound assembly through a first contact interface between the first conductive pin and the elastic sealing component, thereby avoiding generating a first moisture path between the first conductive pin and the elastic sealing component;
wherein a part of the second embedded portion of the second conductive pin is surrounded and covered by the elastic buffer body, so that the elastic buffer body is configured to block external moisture from contacting the wound assembly through a second contact interface between the second conductive pin and the elastic sealing component, thereby avoiding generating a second moisture path between the second conductive pin and the elastic sealing component;
wherein an inner surrounding surface of the surrounding convex end portion of the packaging casing is covered by the elastic buffer body, so that the elastic buffer body is configured to block external moisture from contacting the wound assembly through a third contact interface between the surrounding convex end portion and the elastic sealing component, thereby avoiding generating a third moisture path between the surrounding convex end portion and the elastic sealing component;
wherein the elastic sealing component and the elastic buffer body have the same or different thermal insulation coefficients, the elastic sealing component and the elastic buffer body have the same or different elastic coefficients, and the elastic sealing component and the elastic buffer body have the same or different heat resistances;
wherein the wound capacitor package structure further includes a bottom seat plate, and the bottom seat plate is configured at a bottom side of the packaging casing for cooperating with the packaging casing;
wherein the bottom seat plate has a first through hole and a second through hole, and the first exposed portion of the first conductive pin and the second exposed portion of the second conductive pin respectively pass through the first through hole and the second through hole of the bottom seat plate, and the first exposed portion of the first conductive pin and the second exposed portion of the second conductive pin extend in different directions by bending.

8. The movable device according to claim 5,
wherein the wound assembly is positioned inside the packaging casing through a bottom positioning glue material, the wound assembly is surrounded and covered by a surrounding connecting glue material that is connected between the wound assembly and the packaging casing, and an unoccupied spacing space is formed between the wound assembly and the elastic sealing component;
wherein the packaging casing has an accommodating opening, and the elastic sealing component is disposed at the accommodating opening of the packaging casing for closing and sealing the accommodating opening of the packaging casing;
wherein the first surface of the elastic sealing component is completely covered by the elastic buffer body, and the elastic buffer body is configured to protect the elastic sealing component;
wherein a part of the first embedded portion of the first conductive pin is surrounded and covered by the elastic buffer body, so that the elastic buffer body is configured to block external moisture from contacting the wound assembly through a first contact interface between the first conductive pin and the elastic sealing component, thereby avoiding generating a first moisture path between the first conductive pin and the elastic sealing component;
wherein a part of the second embedded portion of the second conductive pin is surrounded and covered by the elastic buffer body, so that the elastic buffer body is configured to block external moisture from contacting the wound assembly through a second contact interface between the second conductive pin and the elastic sealing component, thereby avoiding generating a second moisture path between the second conductive pin and the elastic sealing component;
wherein an inner surrounding surface of the surrounding convex end portion of the packaging casing is covered by the elastic buffer body, so that the elastic buffer body is configured to block external moisture from contacting the wound assembly through a third contact interface between the surrounding convex end portion and the elastic sealing component, thereby avoiding generating a third moisture path between the surrounding convex end portion and the elastic sealing component;
wherein the elastic sealing component and the elastic buffer body have the same or different thermal insulation coefficients, the elastic sealing component and the elastic buffer body have the same or different elastic coefficients, and the elastic sealing component and the elastic buffer body have the same or different heat resistances;
wherein the wound capacitor package structure further includes a bottom seat plate, and the bottom seat plate is configured at a bottom side of the packaging casing for cooperating with the packaging casing;
wherein the bottom seat plate has a first through hole and a second through hole, and the first exposed portion of the first conductive pin and the second exposed portion of the second conductive pin respectively pass through the first through hole and the second through hole of the bottom seat plate, and the first exposed portion of the first conductive pin and the second exposed portion of the second conductive pin extend in different directions by bending.

9. A method for manufacturing a wound capacitor package structure, comprising:
providing a semi-finished wound capacitor, wherein the semi-finished wound capacitor includes a wound assembly, a conductive assembly, a packaging casing and an elastic sealing component that cooperate with each other;
forming an elastic buffer material on a first surface of the elastic sealing component; and
curing the elastic buffer material to form an elastic buffer body;
wherein the elastic buffer body is configured to slow down an impact force caused by an external force on the wound assembly and reduce a thermal shock caused by an external temperature on the wound assembly.

10. The method for manufacturing the wound capacitor package structure according to claim 9,
wherein the conductive assembly includes a first conductive pin and a second conductive pin, and the packaging casing is configured to accommodate the wound assembly;
wherein the elastic sealing component is disposed inside the packaging casing and cooperates with the packaging casing, and the elastic sealing component is configured to isolate the wound assembly from an external environment;
wherein the first conductive pin includes a first embedded portion accommodated inside the packaging casing and a first exposed portion exposed outside the packaging casing, and the second conductive pin includes a second embedded portion accommodated inside the packaging casing and a second exposed portion exposed outside the packaging casing;
wherein the packaging casing has a surrounding concave position-limiting portion recessed inward to press the elastic sealing component, and a surrounding convex end portion protruding from the surrounding concave position-limiting portion to abut against the elastic sealing component;
wherein the first surface of the elastic sealing component is completely covered by the elastic buffer body, and the elastic buffer body is configured to protect the elastic sealing component;
wherein a part of the first embedded portion of the first conductive pin is surrounded and covered by the elastic buffer body, so that the elastic buffer body is configured to block external moisture from contacting the wound assembly through a first contact interface between the first conductive pin and the elastic sealing component, thereby avoiding generating a first moisture path between the first conductive pin and the elastic sealing component;
wherein a part of the second embedded portion of the second conductive pin is surrounded and covered by the elastic buffer body, so that the elastic buffer body is configured to block external moisture from contacting the wound assembly through a second contact interface between the second conductive pin and the elastic sealing component, thereby avoiding generating a second moisture path between the second conductive pin and the elastic sealing component;
wherein an inner surrounding surface of the surrounding convex end portion of the packaging casing is covered by the elastic buffer body, so that the elastic buffer body is configured to block external moisture from contacting the wound assembly through a third contact interface between the surrounding convex end portion and the elastic sealing component, thereby avoiding generating a third moisture path between the surrounding convex end portion and the elastic sealing component;
wherein the elastic sealing component and the elastic buffer body have the same or different thermal insulation coefficients, the elastic sealing component and the elastic buffer body have the same or different elastic coefficients, and the elastic sealing component and the elastic buffer body have the same or different heat resistances;
wherein the wound capacitor package structure further includes a bottom seat plate, and the bottom seat plate is configured at a bottom side of the packaging casing for cooperating with the packaging casing;
wherein the bottom seat plate has a first through hole and a second through hole, and the first exposed portion of the first conductive pin and the second exposed portion of the second conductive pin respectively pass through the first through hole and the second through hole of the bottom seat plate, and the first exposed portion of the first conductive pin and the second exposed portion of the second conductive pin extend in different directions by bending.
